(19) United States
(12) Patent Application Publication
(10) Pub. No.: US 2002/0063154 A1
(43) Pub. Date: May 30, 2002

(54) Security system database management

(76) Inventors: Hector Hoyos, Guaynabo, PR (US); Alex Rivera, San Juan, PR (US); Miguel Berrios, Guaynabo, PR (US); Ricardo Real, Bayamon, PR (US); Leslie de Jesus, San Juan, PR (US)

Correspondence Address: Patent Law Offices of Health W. Hoglund, 391 Juan A. Davila Street, San Juan, PR, 00918, US

(21) Appl. No.: 09/867,184

(22) Filed: May 29, 2001

Related U.S. Application Data
(60) Provisional application No. 60/207,562, filed on May 26, 2000.

(51) Int. Cl. G06K 7/01

(52) U.S. Cl. 235/382.5

(57) ABSTRACT

A security system database is configured to store a unique identifier and a biometrics feature for each user's. This information is periodically transferred from a central server to a plurality of access controllers. The access controllers in turn control building access based upon the information received from the central server. The access data is in turn periodically transferred from the access controllers to the central server. The central server uses this information to generate access reports.

### FIELD OF THE INVENTION

The present invention relates generally to a computerized security system used to restrict entry to a building or property, and more specifically to the maintenance of a database of user information used in such a security system.

### DESCRIPTION OF RELATED ART

Security systems are widely used to control entry to a building or a property. Where only a few people are permitted access to a property, e.g. a home, the security system may be relatively simple, consisting of a lock with an associated key on every door. Although this security system is acceptable for many homes, it is not suitable for many commercial applications for a number of reasons.

First, as the number of people who require access to a property increases, the security risks generally increase as well. For example, businesses that use a simple lock and associated key on every door typically provide keys to a selected group of employees. Invariably, someone in that group eventually loses a key and that loss poses a potential security hazard. Moreover, businesses typically experience some employee turnover. Although an employee typically returns any building keys upon the termination of his or her employment, this administrative burden is sometimes overlooked and poses an additional security risk.

Second, many commercial buildings require more careful monitoring of the persons who have entered a particular building. For example, a warehouse that is used to store valuable goods will require carefully restricted access. In such applications, a simple lock and associated key for every door is generally inadequate.

In other settings, especially academic or commercial research settings, access may be restricted to prevent loss of trade secret information. In such applications, a property may be divided into different areas. To minimize the risk of loss, employees may be granted access to the different areas only on an as-needed basis. Thus, a person may have access to a main entrance and a specific area but not to the entire property. Although a key and lock security system may be used for these types of settings, the administrative burden of monitoring who has copies of the various keys quickly becomes impractical. Likewise, the cost of providing a security guard at every entrance is not economically or administratively feasible for most applications.

Accordingly, a number of computerized security systems have been implemented to reduce the administrative burden and to reduce the risk of unauthorized entry into a building or property. For example, U.S. Pat. No. 4,210,899, titled “Fingerprint-Based Access Control and Identification Apparatus,” issued to Swonger et al. on Jul. 1, 1980, discloses a security system that uses a human fingerprint to control access. U.S. Pat. No. 4,395,628, titled “Access Security Control,” issued to Silverman et al. on Jul. 26, 1983, discloses another security system that uses a control card to control access. U.S. Pat. No. 5,608,387, titled “Personal Identification Device and Access Control Systems,” issued to Davies on Mar. 4, 1997, discloses still another security system that uses human recognition of a complex image to control access. Each of the above-listed patents is incorporated herein by reference.

Each of the above-listed patents also implements a database that is used to determine whether to grant access. These databases must be maintained on a regular basis as new users are added to the security system and old users are removed from the security system. In addition, the access privileges for an existing user may change. For example, a particular employee may have access only during certain times of the day and only during certain days of the week. This employee's access may be increased to allow at-will access. Likewise, a particular employee may have access only to specific areas in a building. If the employee's responsibilities change, his or her access privileges to specific areas in the building will also likely change. The associated database(s) must be updated to reflect such changes. This administrative burden can become onerous as the number of users and/or access points increase. Accordingly, a database management system is desired that simplifies as much as possible this process.

### SUMMARY OF THE INVENTION

According to one aspect of the invention, a security system database of user information is maintained. The database is used to grant or deny a user access to a property, such as a building. To begin configuration, a central server receives a representation of a fingerprint from a system administrator. The representation of the system administrator's fingerprint is saved in a memory along with access privileges that permit complete system access. Subsequently, the system administrator must present his or her fingerprint in order to gain access to the system. The resulting fingerprint is compared with the representation saved in memory. If a match is detected, the system administrator is permitted access to the database, otherwise not. After gaining access, the system administrator may create access privileges for other users by first entering a new record command. The new user's fingerprint is captured and saved in memory as a record associated with the new user. The system administrator also determines access privileges for the new user.

According to a further aspect of the invention, the fingerprint data is transformed and encrypted to prevent disclosure of private data.

According to another aspect of the invention, the fingerprint data may be replaced by an electronic representation of the user's face.

According to a further aspect of the invention, a user's access privilege information includes access hours, access days and access points.

According to another aspect of the invention, the access to a building is monitored by a security system having a database of user information. The database is established at a central server and includes a unique identifier and a biometric feature for each authorized user's. This database is transferred through a computerized network to a plurality of access controllers. The access controllers receive requests from the users to enter the secure area. The access requests each include a unique identifier and a biometric feature such as a fingerprint. The access request is compared with the database of authorized users to determine access privileges. The comparison is made locally at the access controller. Access records are generated based upon these requests and transferred to the central server. This, in turn, permits the generation of attendance reports at the central server based upon the records of the access requests.

According to a further aspect of the invention, the report of attendance includes records for a single employee that were generated at different access controllers.

According to a further aspect of the invention, the central server polls the access controllers upon generating an access report.

According to another aspect of the invention, a security system includes a central server and a plurality of access controllers. The central server is configured to establish a database of user information including a unique identifier and a biometrics feature for each user. The central server is further configured to generate reports of user access information. The plurality of access controllers coupled with the central server through a network. The plurality of access controllers are each configured to control associated access points based upon the database of user information and to retain access records. The the central server periodically transfers an updated copy of the database of user information to the plurality of access controllers. The plurality of access controllers each periodically transfer an updated copy of access records to the central server for use in generating the reports of user access information.

Further aspects of the invention will be better appreciated in view of the drawings and the description that follows.

### BRIEF DESCRIPTION OF THE DRAWINGS

FIG. 1 is a block diagram of one preferred database of access points.

FIG. 2 is a block diagram of one preferred database of access groups.

Fig. 3 is a block diagram of one preferred database of departments.

FIG. 4 is a block diagram of one preferred database of groups.

FIG. 5 is a block diagram of one preferred database of employment status options.

FIG. 6 is a block diagram of one preferred database of employment type options.

FIG. 7 is a block diagram of one preferred database of access privileges.

FIG. 8 is a block diagram of one preferred database of user access privileges.

FIG. 9 is a block diagram of one preferred database of users' access groups.

FIG. 10 is a block diagram of one preferred database of users' fingerprint data.

FIG. 11 is a block diagram of one preferred database used to store an access log of transactions.

FIG. 12 is a block diagram of one preferred database of user messages.

FIG. 13 is a block diagram of one preferred computerized security system.

FIG. 14 is a flow chart showing one preferred method of adding a new user.

FIG. 15 is a flow chart showing one preferred method of generating a report.

FIG. 16 is a flow chart showing one preferred method of transmitting a message to a user.

### DETAILED DESCRIPTION OF THE PREFERRED EMBODIMENTS

In one preferred embodiment a building includes a number of doors through which a person may enter. A security device, also referred to as a remote access controller, is provided at each such door. The remote access controller includes an electrical control for a locking mechanism that restricts the opening of the associated door. The remote access controller also includes a user interface that includes both a touch screen and a fingerprint sensor. A user may gain entry to the building by placing his or her finger on a fingerprint sensor and keying a unique identifier. The remote access controller includes a computer having software necessary to perform all related control functions.

In some applications, both the entry and the exit from a building will be controlled. In such cases an additional security device, also referred to as a companion user interface, may be provided on the other side of the door. The companion connects with the locking mechanism. To exit the building, or secured area, a user may place his or her finger on a fingerprint sensor and key the unique identifier. The companion does not include a computer and necessary software to perform this functionality, but instead connects with the remote access controller. The remote access controller provides the necessary support. This helps reduce the overall system cost and complexity by reducing the number of computers required for the various access points.

The remote access controller includes a database of user information that is used in determining whether to allow a person access. That database is generated at central server. The central server connects to each of the remote access controllers. The central computer is used to generate the database of user information. It is also used to configure and control the remote access controllers. For example, the central server is used to configure the database of user information to specify the hours during which a particular user may gain access to a particular door or to the entire building. The central server connects with the remote access computers through an Ethernet network.

In addition to these units, the system may include video monitoring. The video monitoring includes intelligent video surveillance and exception generation capability. These capabilities may be tied with the employee fingerprint ID logs from the remote access controllers. The video surveillance also connects to the remote access controllers through the Ethernet network.

Preferred embodiments of the central server, remote access controllers and companion user interfaces are further described below and in the related application Building Security System, to Hoyos, et al., filed May 29, 2001, Application No. __/__,__, which is incorporated herein by reference.

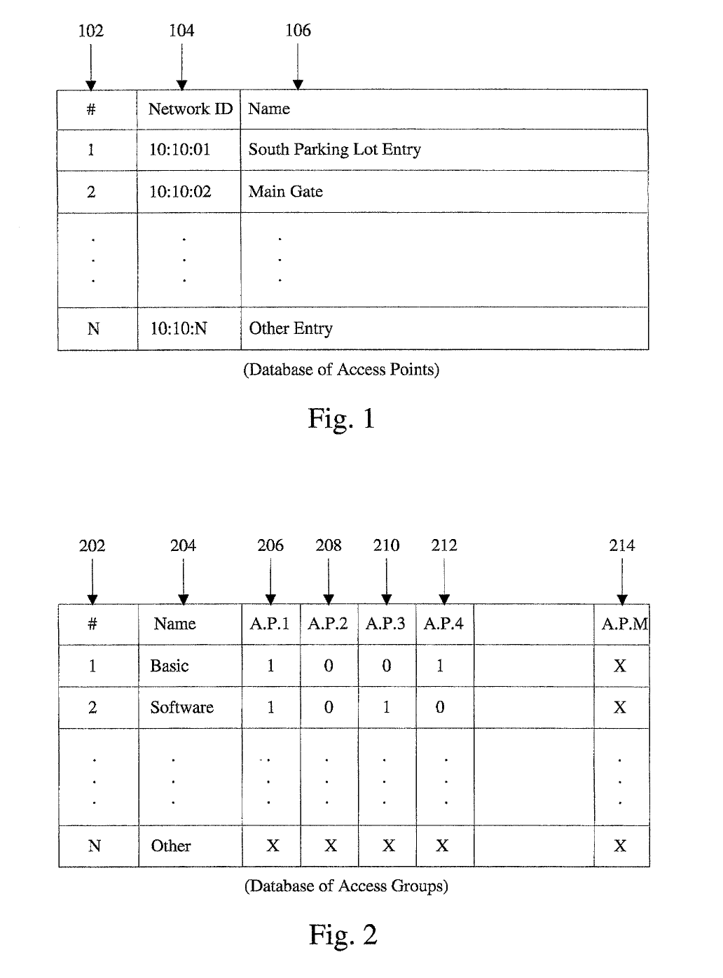

Preferred embodiments of the database are also described below with reference to the figures. More particularly, FIGS. 1-10 show aspects of the database that are used to enroll users and to grant them access privileges to various access points. These access privileges are entered and configured through a central server, and transferred through a computerized network to remote access controllers. The remote access controllers receive access requests and determine whether to permit entry through an associated access point based upon the user's information and the database of access privileges. Each of the remote access controllers saves a database log of access attempts. These logs are transferred through the computerized network to the central server.

The central server compiles the access logs from the various remote access controllers into a common access log database. A system administrator can generate reports based upon the access log database. One preferred access log is shown in FIG. 11.

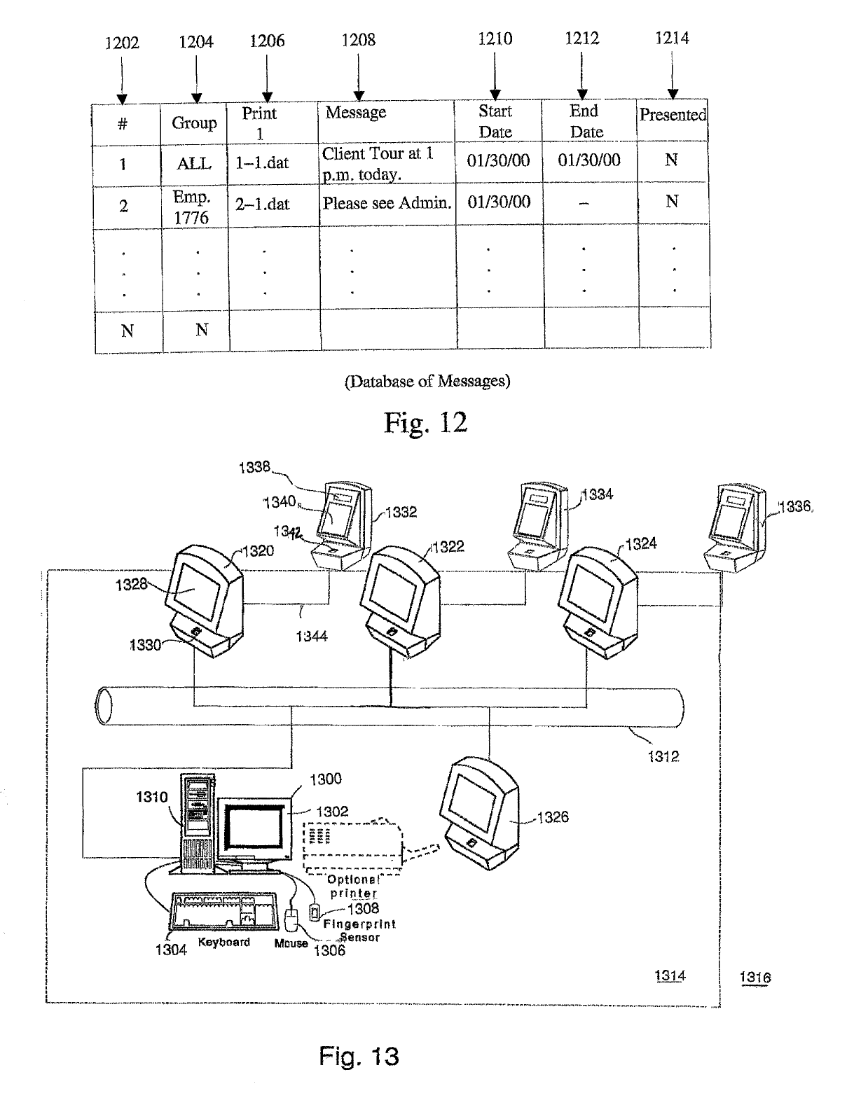

A system administrator is also able to send messages through the central server. The message and recipients are selected, then the message is transmitted through he computerized network to the remote access controllers. When the intended recipient accesses one of the remote access points, the associated remote access controller presents the message. One preferred message database is shown in FIG. 12.

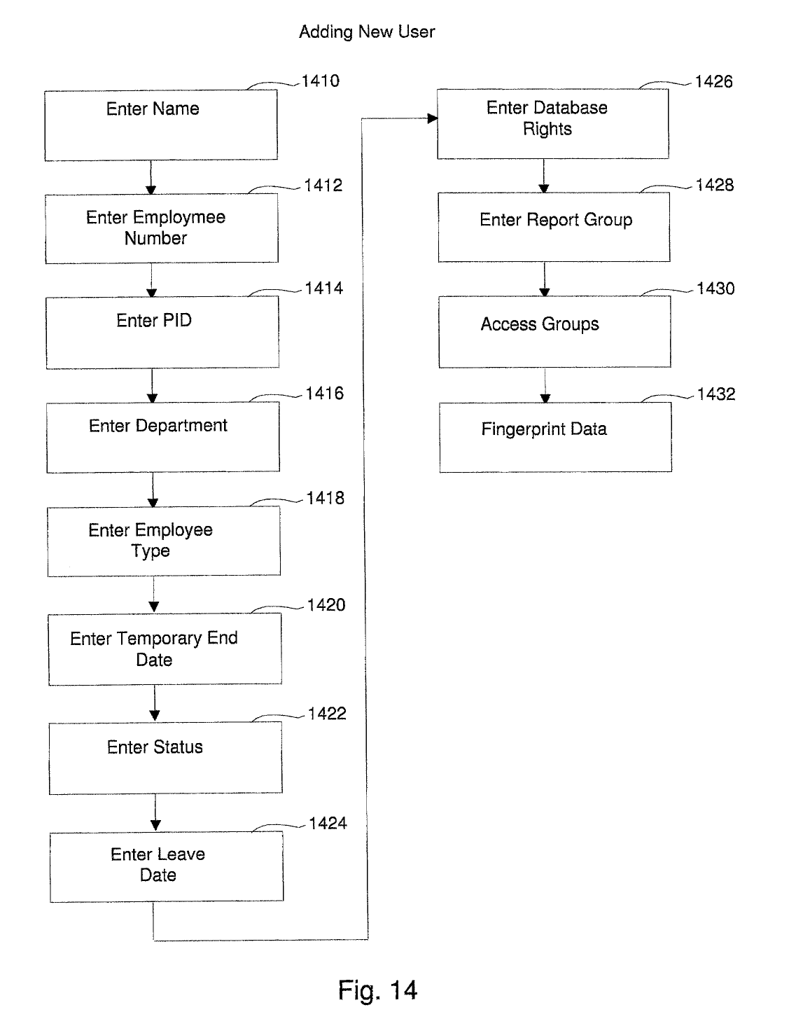

One preferred computerized security system is shown in FIG. 13. It includes a central computer 1300. The central computer 1300 includes a display 1302, a keyboard 1304, a mouse 1306 and a fingerprint sensor 1308. The central computer 1300 also includes a processor and a memory configured to store a database of user information. The processor and memory are housed within enclosure 1310 and operationally coupled with the other components of the central computer 1300. Preferably, the central computer 1300 operates using Windows NT, though other operating systems configured to support a network could also be used.

The central computer 1300 connects through a network 1312 to a plurality of remote computers 1320, 1322, 1324 and 1326. The remote computers 1320, 1322, 1324 and 1326 are positioned within the interior of an access area 1314. Access to this area is restricted to authorized users. Remote computer 1320 includes a processor and memory. Remote computer 1320 also includes a touch screen 1328 and a fingerprint sensor 1330.

Remote computer 1320 receives user data from central computer 1300 through the network 1312. The user data is stored locally in memory. In a default state, touch screen 1328 displays a prompt message advising a user to place his or her finger upon the fingerprint sensor 130 in order to begin the access process.

Preferably, when a user presents his or her finger to the fingerprint sensor 1330, an electronic representation is generated. This representation is pre-processed to extract salient features for comparison. Meanwhile, the user prompted to enter his or her ID through a keypad presented on touch screen 1328. The user's ID is used to access the appropriate database record. The representation of a fingerprint associated with that record is compared with the pre-processed fingerprint to detect a match. If this comparison generates a match, then the remote computer 1320 changes the state of an external circuit controlling the associated access point. This permits the user to pass through the access point.

In a second alternative embodiment, when a user presents his or her finger to the fingerprint sensor 1330, an electronic representation is generated. That representation is compared to the local database of user information. If it generates a match, then a message is displayed on touch screen 1328. Preferably, the message includes the user's name and advises the user to enter his or her user ID. At this time a keypad is also displayed on the touch screen 1328. The user may then enter a password. If the password matches the user's password from the local database, then the remote computer 1320 changes the state of an external circuit controlling the associated access point. This permits the user to pass through the access point.

By retaining a local database of user information, the system reduces downtime due to any network failures. For example, if for any reason central computer 1300 crashes or becomes unavailable, remote computer 1320 is still able to control access based upon a copy of the user database that is retained locally.

Remote computers 1322, 1324 and 1326 function in the same manner as remote computer 1320. Remote computers 1320, 1322 and 1324 each connect with a user interface 1332, 1334 and 1336, respectively through a communication channel. Preferably communication channel 1344 is made as an RS-422 and a parallel connection. User interfaces 1332, 1334 and 1336 are positioned in an unsecured area 1316 surrounding access area 1314.

User interface 1332 includes a display 1338, a keypad 1340 and a fingerprint sensor 1342. Preferably, user interface 1332 does not include a computer processor or associated memory. This background support is provided by remote computer 1320. This configuration helps to reduce system cost and complexity by reducing the total number of computers.

User interface 1332 functions, in many respects, in the same manner as computer 1320 itself. As a user approaches, display 1338 prompts the user to present his or her finger on fingerprint sensor 1342. An electronic representation is generated and passed through communication channel 1344 to remote computer 1320. Remote computer 1320 pre-processes the representation. Meanwhile, remote computer 1320 commands user interface 1332 to present a message to the user requesting entry of the user's ID. The user then enters an ID through keypad 1340. The ID is transmitted through communication channel 1344 to remote computer 1320. The pre-processed representation of a user's fingerprint is then compared with the appropriate database entry. If it matches, the remote computer 120 changes the state of a circuit that controls the associated access point. This permits the user to pass through the associated access point. Otherwise, remote computer 1320 commands user interface 1332 to present a message on display 1338 that the fingerprint did not match. The user may then re-attempt the access process.

Remote computer 1322 and user interface 1334 operate in the same manner as remote computer 1320 and user interface 1332. Likewise, remote computer 1324 and user interface 1336 operate in the same manner as remote computer 1320 and user interface 1332. Remote computer 1326 functions in the same manner as remote computer 1320, except that it is not associated with another user interface. In the configuration shown, remote computer 1326 would control an exit-only access point since it is located within access area 1314.

According to another aspect of the invention, the security system is used to monitor time in and time out for system users. In operation, the remote computers 1320, 1322, 1324 and 1326 can transmit to central computer 1300 the time in and time out of each user. A database for this information is maintained on the central computer 1300. When the remote computer recognizes a user by generating a feature and user ID match, that information is sent through the network 1312 to central computer 1300. The system administrator may generate reports or transfer this data to other applications.

In an alternative preferred embodiment, a particular user may be given access permission only to certain access points. In this configuration, the respective remote computer will also check for access privileges. If the user does not have access privileges for the associated access point, then the remote computer will not permit access through that access point. For example, a user may have access privileges for the access point associated with remote computer 1320 and user interface 1332, but not for any other access point. In this configuration, when the user is properly identified at the access point then he or she will be permitted to pass through the access point. However, when the user attempts to access any other access point, the user will be advised that he or she does not have privileges for that access point.

In yet another preferred embodiment all of the remote computers and user interfaces are positioned outside the access area 1314, in unsecured area 1316. In this configuration, each remote computer and each user interface is used to control a different access point. Once a user gains access to and enters access area 1314, then the user may exit by operating a simple control switch. The control switch automatically permits exit.

The configuration of the database begins by establishing a system administrator. For maximum system security, the system immediately requests that the system administrator present his or her fingerprint and enter a personal identifier. This will be required to make subsequent access of the system as the administrator.

Returning to FIG. 1, one preferred database structure used to maintain the database of user access privileges is described. In particular, one preferred structure for identifying the various access points is described. Specifically, the database of access points includes a number column 102, a network ID column 104, and a name column 106. As with the database structures that will be described below, the first row lists a column descriptor. The following rows each comprise one entry, so that each entry includes one field for each column. With reference to FIG. 1, the number column 102 simply identifies the memory location of the particular entry. The network ID column 104 is used to save the network ID for each remote access controller. The name column 106 is used to save a common name that identifies the access point. This name is used in report generation.

In alternative preferred embodiments, one remote access controller may be used to control access to more than one access point. In addition, the remote access controller may be connected to additional user interfaces that do not themselves connect to the computerized network. Nonetheless, these user interfaces are used to control access to an access point and are controlled by the associated remote access controller. In such configurations, the database further includes fields for the additional access points and user interfaces. Each is also given a common name for use in generating reports.

In typical applications, a remote access controller is placed on the inside of an access point and an additional user interface is placed on the outside of the access point. This configuration permits control of both the entry and exit at an access point. For reference purposes, the names would include an entry and exit identifier, as for example, “Main Gate-Entrance Side,” and “Main Gate-Exit Side.”

The various access points are preferably organized into access groups. In operation a system administrator defines a group and associates various access points with the group. For example, a company may have an engineering department located in a particular area of a building. That area will have a number of access points. Rather than grant access privileges to each user for each access point, the access points for the engineering area are associated with an engineering group. Later, employees that work in that group can be given access more simply by granting privileges to the engineering group. Such privileges will include access privileges to all access points associated with the engineering group.

With reference to FIG. 2, one preferred database of access groups is described. It includes an entry number column 202, a group name column 206, and a plurality of access point columns 206-214. Each access column is associated with one access point. For example, access column 206 is associated with the first access point. In FIG. 1, this would be the South Parking Lot Entry. Each of the entries across a row of access columns 206-214 are set or cleared to permit or deny access to the associated group.

The first group, basic, permits access only to the first and fourth access points. The second group, software, permits access only to the first and third access points. Additional groups may be defined depending upon the requirements of the particular application. A user may be given access to one or more access group. These may be categorized by department or by areas of a building or any other desired organization.

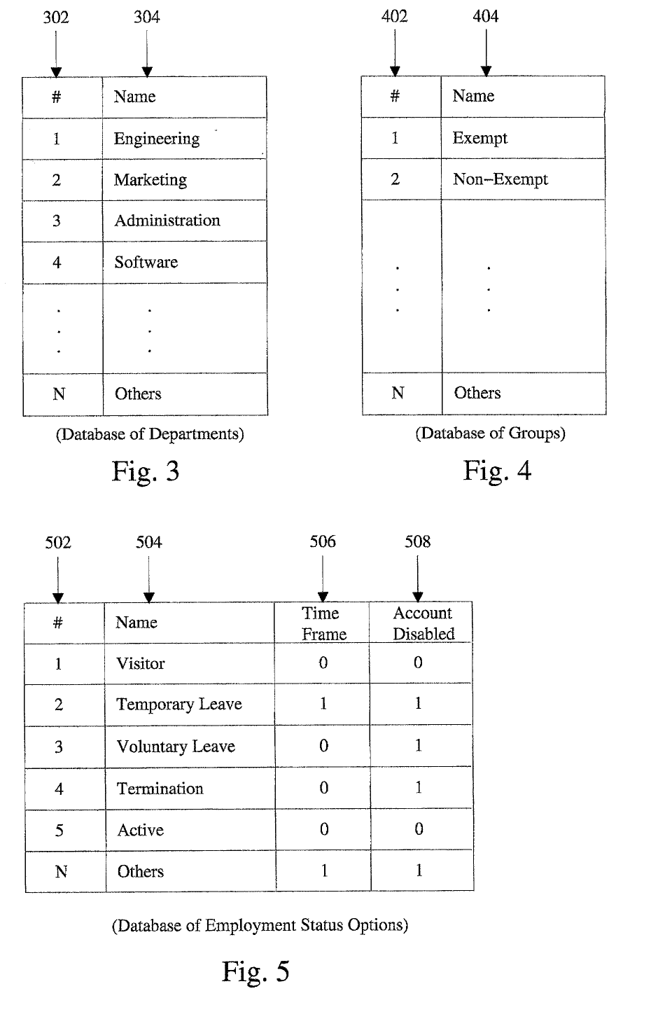

In addition to access groups, the database also includes a departments and groups, which are described with reference to FIGS. 3 and 4, respectively. Each employee may be associated with these groups. Later, reports may be generated by group to monitor the time and attendance by various categories.

With reference to FIG. 3, the database of departments includes an entry number column 302 and a name column 304. Typically, these will follow the organizational configuration of the company that implements the system. For example, this database may include an engineering, marketing, administration and software departments. Each user will be associated with one of these departments. With reference to FIG. 4, another database of groups includes an entry number column 402 and a name column 404. As shown, these may include a number of categories such as exempt and non-exempt. Each user is classified in one of these groups. Later, this field can be used to limit the results of a particular report.

For example, a report of the attendance of only exempt users may be created. The members of this group are determined by their association with this group. In addition to providing reporting groups, the database also includes a number of employment status options. These permit various combinations for disabling a user's account and for setting a fixed time frame for a user's account. The account disabled permits an administrator to disable an existing account without removing or deleting that account from the system. The time frame option is set to remind the system administrator that a particular user's access rights should change. In one preferred configuration, an automatic report engine is run on the database. That report engine searches for employees having a fixed time of employment or active status. If that is about to end, the report engine notifies the administrator so that he or she can change the employees status and disable their account.

More specifically, the database as shown with reference to FIG. 5 includes an entry number column 502, a name column 504, a time frame column 506 and an account disabled column 508. Preferably, the database includes five named entries. A visitor entry has neither a fixed time frame nor an account disable set. A temporary leave entry has both a time frame and an account disable set. A voluntary leave entry has a time frame cleared and an account disable set. An active entry has both a time frame and an account disabled cleared. A user associated with a temporary or voluntary leave entry or a termination entry will have their account disabled. This ends any access privileges.

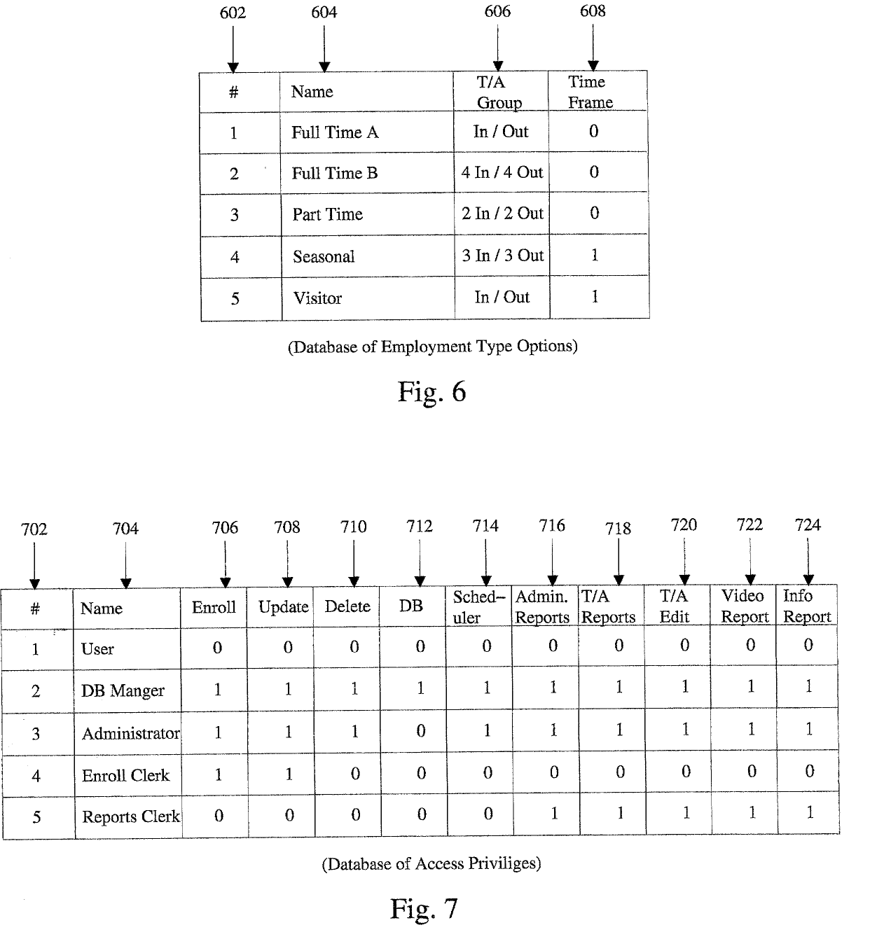

With reference to FIG. 6, employee type information can also be configured to track time in and time out punch sequences. For many hourly employees, the time in and time out are important for determining paycheck amounts. For salary employees, this information is less important for that purpose. For report generation, a number of in and out groups are provided. Preferably these include groups with one through four in and out punch pairs. When enrolling a new employee, the appropriate group is selected.

As shown, the database of employment type options includes an entry number column 602, a name column 604, a time and attendance group 606 and a time frame group 608. The time frame group functions in the same manner as the time frame column 506 of FIG. 5. If either of these are selected for a particular user, then the administrator will be notified as the employees time frame comes to an end.

Finally, the database includes a collection of access privileges. These are described with reference to the database of access privileges shown in FIG. 7. It includes an entry number column 702 and a name column 704. It also includes a number of columns that grant access privileges to the database. These include an enroll column 706, an update column 708, a delete column 710, a database column 712, a scheduler column 714, an administrator reports column 716, a time and attendance reports column 718, a time and attendance edit column 720, a video report column 722 and an information report column 724.

The privileges grant rights as follows. The enrollment rights permit a user to enroll other users. The update rights permit a user to alter existing user entries. The delete rights permit a user to delete an existing user entry. The database management rights permit a user to make configuration changes to the database. The scheduler rights permit a user to make changes to scheduled events such an automatic report generation. Administrator reports rights permit a user to create administrative reports, this is the broadest level of rights. The time and attendance reports rights permit a user to generate this type of report. The time and attendance edit rights permit a user to edit a time and attendance report. The video report rights permit a user to generate video reports.

In a preferred embodiment, a video image of a user is captured upon accessing the security system. The video reports are stored along with user logs and can be reported. Finally, the info reports permit all other types of reports such as a report of user names.

In one preferred embodiment, the database of access privileges is configured with five different settings. These include a user, database manager, administrator, enrollment clerk and reports clerk with the access privileges shown in FIG. 7.

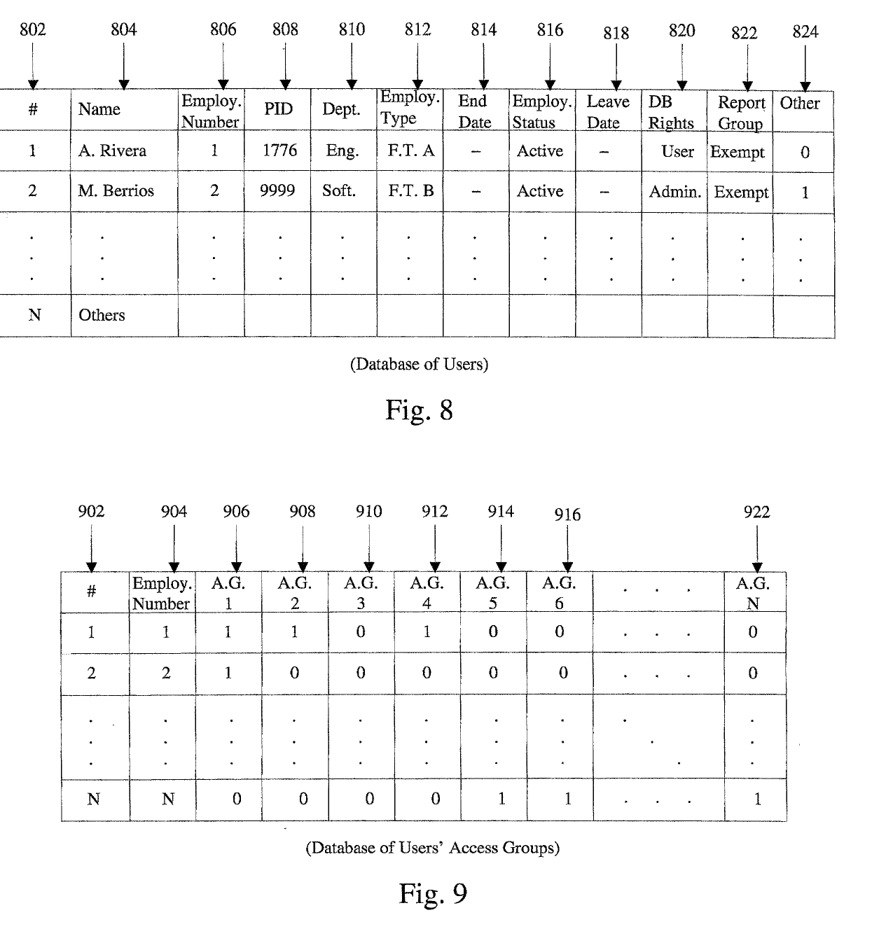

After configuring the above database options, the database is ready to receive actual user information. One preferred database of user information is shown in FIG. 8. It includes an entry number column 802 and a name column 804. It also includes a number of user information columns 806-824.

More specifically, these include an employee number column 806. The employee number is assigned by the system administrator. It includes a personal identification number (PID) column 808. This is a secret number that may be selected by the new user.

It includes a department column 810. This selection is made from the database of departments described above with reference to FIG. 3. The entry links or points to one of those options.

It includes an employee type column 812. This selection is made from the database of employment type options described above with reference to FIG. 6. This entry links or points to one of those options. It includes an end date column 814. This is an optional entry and depends upon the selection made for the employee type column 812. For example, where a visitor is selected, the time frame is ordinarily limited to one day. The appropriate date is entered in the end date column 814 and the administrator will receive a report message on the end date notifying the administrator that the visitors access privileges have expired.

It includes an employee status column 816. This selection is made from the database of employment status options described above with reference to FIG. 5. The entry links or points to one of those options. Where the employment status option includes a time frame limitation (such as for temporary leave), then the leave date column 818 is also used.

It also includes a database rights column 820. This selection is made from the database of access privileges described above with reference to FIG. 7. It further includes a report group column 822. This selection is made from the database of report groups described above with reference to FIG. 2. Finally, it may include one or more optional columns 824 that are configured for a special application. For example, the user's access days or hours may be restricted, or other limitations applied.

After configuring the user options described with reference to FIG. 8, access privileges must be assigned to each user. These are maintained in a database of users' access groups shown in FIG. 9. It includes an entry number column 902 and an employee number 904. The employee number 904 corresponds to the employee numbers of column 806 shown in FIG. 8. In other words, this database includes a record for each record of FIG. 8.

In particular, the database includes access group columns 906-922. Each column is associated with one of the access groups described above with reference to FIG. 2. For example, access group 1, identified by column 906, grants rights to the basic group of FIG. 2. Likewise, access group 2, identified by column 908, grants rights to the software group of FIG. 2. For each user, one or more of these groups are selected to grant access rights to various access points associated with the access groups.

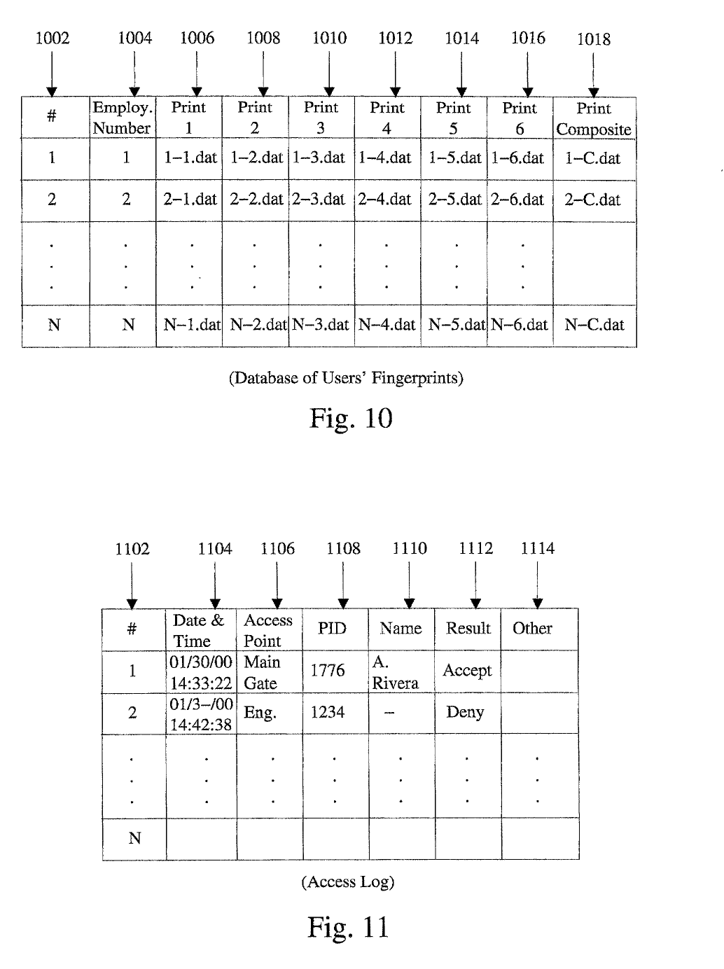

Finally, after configuring a users' access information, a biometrics database record is created. Preferably, six scans of the users' thumbprint are made. This data is compressed in an encrypted format and saved in a database of users' fingerprints as shown in FIG. 10. More specifically, this database includes a record number column 1002, and an employee number column 1004. Again, the employee number column is associated with the employee number column 806 of FIG. 8. The fingerprint data are saved as pointers to database entries along the columns 1006 through 1016. In addition, a composite print is derived from the six entries. This composite is used for matching by remote access controllers.

After configuring the database on the central server, the user records are transferred through the computerized network to the remote access controllers. The remote access controllers use this information to grant or deny access at an access point. During operation the remote access controllers save a log of access information for each user (or attempted intruder) interaction. These logs are periodically transferred to the central server for use in creating various reports.

Turning to FIG. 11, one preferred access log is described. It includes a record number column 1102. A date and time column 1104. This column records the date and time of the user transaction. It includes an access point column 1106. This records the name identifier of the access point. It includes a PID column 1108. When a user attempts to enter an access point, they are prompted to present their fingerprint for scanning and to enter a PID. The PID is saved in the access log. The associated name is also saved in name column 1110. In an alternative embodiment, the employee number is used instead of the PID. In yet another alternative embodiment, both the employee number and PID are used in conjunction with the fingerprint scan to ensure the highest level of security. It also includes a result column 1112. This indicates whether the transaction resulted in a successful access.

In operation, the transaction can fail either because the user does not enter a valid employee number, or because the user does not present a fingerprint match, or because the user did not have privileges to the particular access point. In addition, the access log can include optional columns, shown as 1114, used to indicated equipment failures or damage, or emergency entries or exits, or any other preconfigured condition.

After establishing operation of the database and related security system, a system administrator can transmit a message to a user as they access a remote access controller or related user interface. This process is initiated by entering a message record in a message database through the central server. One preferred database structure is shown in FIG. 12. In particular, this includes a record number column 1202. It also includes a group column 1204. When entering a message, the system administrator may select to send it to all users, a particular employee, a department or a report group. Depending upon which one is selected, the record includes the respective identifier.

In addition, the record includes a message column 1208. This provides a short space, preferably up to 300 characters, to enter a message. The record includes a start and an end date column, 1210 and 1212, respectively. Finally, the record includes a presented column 1214. This column indicates if the recipient(s) has(have) received the message.

Turning to FIG. 14, the process for adding a new user is described. First, at block 1410, the administrator enters the user name. At block 1412, the administrator enters the employee (or user) name. At block 1414, the employee enters his or her preferred personal identifier. At block 1416, the administrator selects a department.

At block 1418, the administrator selects an employee type. At block 1420, the administrator enters a temporary end date, if appropriate. At block 1422, the administrator enters a status option, and at block 1424 a leave date if appropriate. At block 1426, the administrator selects database rights and at block 1428 selects a report group. At block 1430, the administrator selects access groups. Finally, at block 1432 the new user presents his or her fingerprint for scanning. A number of duplicates are taken and processed to create a comparison template.

After receiving a new entry, the central server transmits the updated database records to the remote access controllers. The updated database information is used in future access transactions. This completes the enrollment process and the new user is able to access the security system.

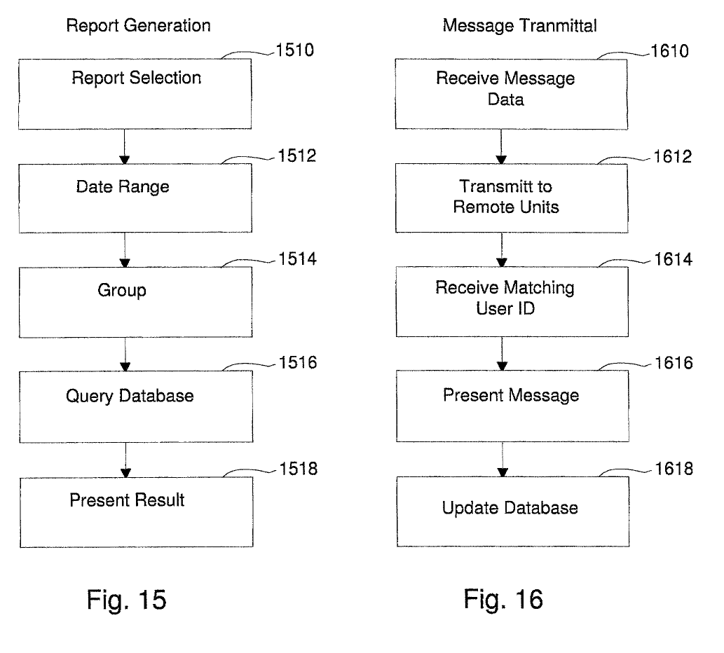

As described above, the system also maintains a log of user access requests. These logs are used to generate various reports. One preferred process is described with reference to FIG. 15 along with the generation of a time report for a particular employee. Beginning at step 1510, the administrator selects between various report options including a time and attendance report, an intruder report, and a simple employee list.

Here, the administrator selects a time and attendance report. Then, at block 1512, the administrator enters a date range. At block 1514, the administrator enters a group. Here, a single employee is entered and so the employee number is also provided or the employee name selected. At block 1516, the central server queries the database of user information to generate the report. Finally, at block 1518, the results are presented. Since data from the various access controllers accumulates at the central server, the reports include all entrance and exit, or log in and log off, data for a user.

In addition, the time and attendance report can be generated automatically at predetermined intervals and the resulting data exported to other applications. This is especially useful for accounting purposes for hourly employees. In such applications, the system ensures building security and at the same time provides accurate records of actual attendance. The fingerprint matching ensures that the record entries were made by the employee at the time of accessing an access point.

The data at the central server is merely a copy of the user logs created at the various remote access controllers. The central server periodically polls these units to update its database. In addition, when the administrator requests a new report, the central server immediately polls the remote access controllers to update the database.

On preferred time and attendance report includes employee name, identification, date, times and access point data as shown in the following Table 1:

TABLE 1

| Name | ID | Date | Time | Access Point |
|---|---|---|---|---|
| A. Rivera | 1776 | 03/01/00 | 07:30:16 | Main Gate Entr. |
| | | 03/01/00 | 10:10:56 | Main Gate Exit |
| | | 03/01/00 | 10:30:33 | Main Gate Entr. |
| | | 03/01/00 | 12:18:01 | Software Exit |
| | | 03/01/00 | 13:05:42 | Main Gate Entr. |
| | | 03/01/00 | 18:11:54 | Software Exit |

Turning to FIG. 16, one preferred method of delivering a message to a user is described. Beginning at step 1610, the administrator enters a new message record. This includes one or more intended recipients and a message. The record may also include a start and end date. At step 1612, the message is transmitted to the remote access controllers where it is saved in a local message database. Here, the remote access controller monitors incoming access requests. These requests include a user identification that is compared with the message database. At step 1614, the remote access controller detects a match either directly as when the message is directed to the specific user or indirectly as when the message is directed to a group to which the user belongs. Then, at step 1616, the remote access controller presents the message. The message database is updated to reflect that the message has been presented to the particular user. This information is also transmitted to the central server.

Although the invention has been described with reference to specific preferred embodiments, those skilled in the art will appreciate that many modifications and variations are possible without departing from the scope of the invention. All such modifications and variations are intended to be encompassed by the following claims.

We claim:

1. A method of creating a user database suitable for use in conjunction with a security system to grant or deny a user access to a property, such as a building, comprising the steps of:
receiving first data from an input device representing a biometric feature of an administrator;
saving the first data in a memory as a record associated with the administrator;
saving access privilege information in the record associated with the administrator;
receiving second data from the input device representing the biometric feature of the administrator and comparing the second data to the first data to detect a match;
receiving a command from the administrator to create a user record associated with a user;
receiving third data from the input device representing a biometric feature of the user;
saving the third data in the memory as a record associated with the user; and
saving access privilege information in the record associated with the user.

2. The method of claim 1, wherein the step of receiving first data from the input device comprises receiving an electronic representation of a fingerprint of the administrator.

3. The method of claim 17 wherein the step of saving the first data in the memory comprises transforming the first data into a mathematical representation so that the first data cannot be reconstructed from the mathematical representation and saving the mathematical representation.

4. The method of claim 1, wherein the step of saving access privilege information in the record associated with the administrator comprises saving an indicator bit for each of user enrollment rights, user update rights, user deletion rights, data base management rights, and report rights, wherein when the indicator bit is set the associated administrator may exercise the right and when the indicator bit is not set the associated administrator is prohibited from exercising the right.

5. The method of claim 1, wherein the step of receiving second data from the input device representing the biometric feature of the administrator and comparing the second data to the first data to detect the match comprises generating a mathematical representation of the second data, wherein the mathematical representation is insufficient to reconstruct the second data.

6. The method of claim 1, wherein the step of receiving the command from the administrator to create the user record associated with the user, comprises receiving a new user command along with access rights for the user.

7. The method of claim 1, wherein the step of receiving third data from the input device representing the biometric feature of the user comprises receiving image data representing the user's face.

8. The method of claim 1, wherein the step of saving the third data in the memory as the record associated with the user comprises saving a mathematical representation of the third data from which the third data cannot be reconstructed.

9. The method of claim 1, wherein the step of saving access privilege information in the record associated with the user comprises saving access hours, access days and access points.

10. A method of monitoring access to a building comprising the steps of:
establishing a database of authorized users at a central server wherein the database includes a unique identifier and a biometric feature for each authorized user;
transferring the database of authorized users though a computerized network to a plurality of access controllers;
receiving access requests at the plurality of access controllers, wherein the access requests each include a unique identifier and a biometric feature and comparing the access requests with the database of authorized users to determine access privileges, wherein each comparison is made with a database of user information stored by the access controller that received the access request;
transferring records of the access requests from the access controllers through the computerized network to the central server; and
generating a report of attendance at the central server based upon the records of the access requests.

11. The method of claim 10, wherein the report of attendance includes records for a single employee that were generated at different access controllers.

12. The method of claim 10, wherein the step of establishing a database of authorized users' further comprises establishing a system administrator, and wherein subsequent access to the central server requires the system administrator to present a biometrics feature.

13. The method of claim 10, wherein in the step of establishing the database, the biometrics feature comprises a fingerprint.

14. The method of claim 10, wherein the step of establishing a database of authorized users further comprises establishing associated access rights limited to a subset of all access points.

15. The method of claim 10, wherein the step of of generating a report further comprises polling the access controllers to obtain updated records of the access requests from the access controllers.

16. A security system comprising:
a central server configured to establish a database of user information including a unique identifier and a biometrics feature for each user, and further configured to generate reports of user access information; and
a plurality of access controllers operationally coupled with the central server through a network and configured to control associated access points based upon the database of user information and to retain access records;
wherein the central server periodically transfers an updated copy of the database of user information to the plurality of access controllers, and wherein the plurality of access controllers each periodically transfer an updated copy of access records to the central server for use in generating the reports of user access information.
